(19) United States
(12) Patent Application Publication
(10) Pub. No.: US 2009/0267794 A1
(43) Pub. Date: Oct. 29, 2009

(54) LIGHT EMITTING DIODE BASED TRAFFIC LIGHT MODULE

(75) Inventors: CHIA-SHOU CHANG, Tu-Cheng (TW); PAI-SHENG WEI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/137,521

(22) Filed: Jun. 11, 2008

(30) Foreign Application Priority Data
Apr. 28, 2008 (CN) 200810066869.0

(51) Int. Cl. G08G 1/095

(52) U.S. Cl. 340/907

(57) ABSTRACT

A traffic light module (10) includes three substrates (14, 15, 16) and three groups of LEDs (11, 12, 13) respectively mounted on the substrates. The substrates are spaced from each other. The LEDs of each group are arranged in a particular shape to define a symbolic sign.

### BACKGROUND OF THE INVENTION

1. Field of the Invention

The present invention relates to traffic light modules, and more particularly, relates to a light emitting diode (LED) traffic light module which has an improved heat dissipation efficiency.

2. Description of Related Art

As an energy-efficient light source, LED traffic light modules are used to replace incandescent lamps as traffic indicators. The LED traffic light module provides the advantages of generally consuming less power, of working more efficiently, of being cost effective, and of not burning out as often as an incandescent lamp.

A related art disclosed in U.S. Pat. No. 6,054,932 provides a conventional traffic light module having three signal lights embedded in a single opening of a housing. Each of the signal lights includes a plurality of LEDs having a specific color being arranged in a corresponding symbolic shape. However, all the LEDs of the three signal lights are mounted on one circuit board in a high density and a large amount of heat generated by the LEDs can not be quickly dissipated and accumulates in the housing. As a result, the LEDs may become overheated, significantly reducing work efficiency and service life thereof.

What is needed, therefore, is an LED traffic light module which can overcome the above-mentioned disadvantages.

### SUMMARY

According to an embodiment of the invention, a traffic light module includes a first substrate having a first group of LEDs mounted thereon and a second substrate having a second group of LEDs mounted thereon. The first group of LEDs are arranged in a first particular shape to define a first symbolic sign. The second group of LEDs are arranged in a second particular shape to define a second symbolic sign. The first and second substrate are spaced from each other and stacked with one above another with a gap defined between the first and second substrates.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is a schematic view of a cross-section of a traffic light module in accordance with a first embodiment of the present invention;

FIG. 2 is a top view of a symbolic sign shown in the shape of a letter “X” in the traffic light module of the embodiment;

FIG. 3 is a top view of a symbolic sign shown in the shape of a letter “O” in the traffic light module of the embodiment;

FIG. 4 is a top view of a symbolic sign shown in a triangular shape in the traffic light module of the embodiment;

FIG. 5 is a front side, schematic view of a traffic light module in accordance with a second embodiment of the present invention;

FIG. 6 is a front side, schematic view of a traffic light module in accordance with a third embodiment of the present invention; and

FIG. 7 is a left side view of a traffic light indictor incorporating therein the traffic light module.

### DETAILED DESCRIPTION

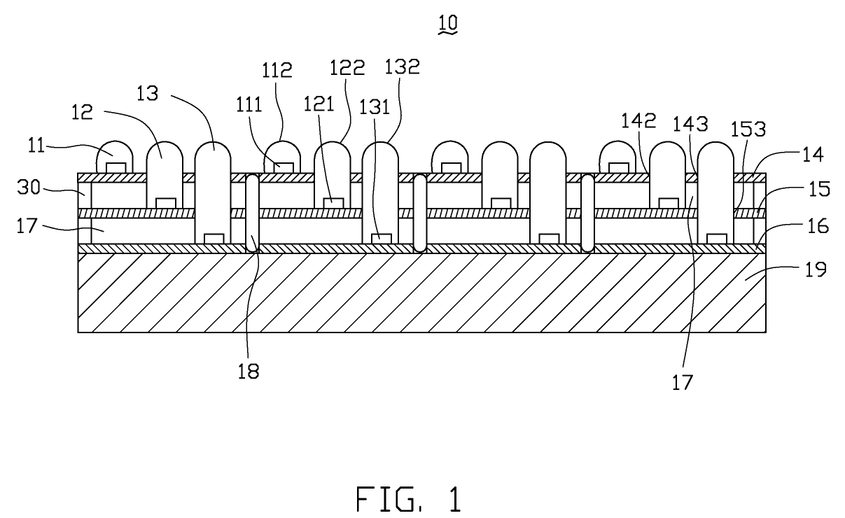

Referring to FIG. 1, a traffic light module 10 comprises three substrates 14, 15, 16 each having a group of same color LEDs 11, 12, 13 mounted thereon. The three groups of LEDs 11, 12, 13 have different colors so as to indicate corresponding signals, respectively. Each group of the three groups of LEDs 11, 12, 13 is arranged in a corresponding symbolic shape and illuminated to define the corresponding signal.

The substrates 14, 15, 16 are respectively named as first substrate 16, second substrate 15 and third substrate 14 for facilitating reading of the specification. The first substrate 16 is attached to a supporting base 19. The second substrate 15 is supportively connected to the supporting base 19 by a plurality of fixing components 30, which extend along the vertical direction. The second substrate 15 is hung above and parallel to the first substrate 16, and a vertical gap 17 is formed between the first substrate 16 and the second substrate 15. The third substrate 14 is supportively connected to the supporting base 19 by a plurality of fixing components 30 and hung above the second substrate 15. The third substrate 14 is parallel to the second substrate 15 and another vertical gap 17 is formed between the second substrate 15 and the third substrate 14. In other words, the first substrate 16, the second substrate 15 and the third substrate 14 are stacked with one above another along the vertical direction with the two vertical gaps 17 formed between neighboring substrates 14, 15, 16.

The first group of LEDs 13 is mounted on the first substrate 16. Each of the LEDs 13 comprises a yellow LED chip 131 and a lens 132 covering the LED chip 131. The second group of LEDs 12 is mounted on the second substrate 15. Each of the LEDs 12 comprises a green LED chip 121 and a lens 122 covering the LED chip 121. The third group of LEDs 11 is mounted on the third substrate 14. Each of the LEDs 11 comprises a red LED chip 111 and a lens 112 covering the LED chip 111.

The first group of LEDs 13 mounted on the first substrate 16 is received in the gap 17 defined between the first and second substrates 16, 15 and extends upwardly through the second substrate 15 and the third substrate 14 to emit light out of the traffic light module 10. The second group of LEDs 12 mounted on the second substrate 15 is received in the another gap 17 defined between the second and third substrates 15, 14 and extends upwardly through the third substrate 14 to emit light out of the traffic light module 10. The third substrate 14 defines a plurality of through holes 142, 143 corresponding to the LEDs 12, 13 along the vertical direction, for extension of the LEDs 12, 13 therethrough, respectively. The second substrate 15 defines a plurality of through holes 153 corresponding to the LEDs 13 along a vertical direction, for extension of the LEDs 13 therethrough. The lens 122 of each green LED 12 is made to have an elongated configuration so as to extend out of the third substrate 14 through the corresponding through hole 142 of the third substrate 14. The lens 132 of each yellow LEDs 13 is made to have an elongated configuration so as to extend out of the third substrate 14 through the through holes 153, 143 of the substrates 15, 14. The third group of LEDs 11 mounted on the third substrate 14 is located on the top side of the traffic light module 10.

Each of the substrates 14, 15, 16 has a planar top surface on which the corresponding LEDs 11, 12, or 13 are mounted. The substrates 14, 15, 16 are evenly spaced from neighboring one along the vertical direction. The fixing components 30 can be screws or other fasteners. The substrates 14, 15, 16 typically are circuit boards. A plurality of heat pipes 18 connect vertically with the substrates 14, 15, 16 through corresponding holes (not labeled) defined in the substrates 14, 15, 16. The heat pipes 18 are thermally soldered to the substrates 14, 15, 16 to enhance heat transferring between the substrates 14, 15, 16. The two gaps 17 defined between the adjacent substrates 14, 15, 16 are provided for improving natural convection cooling.

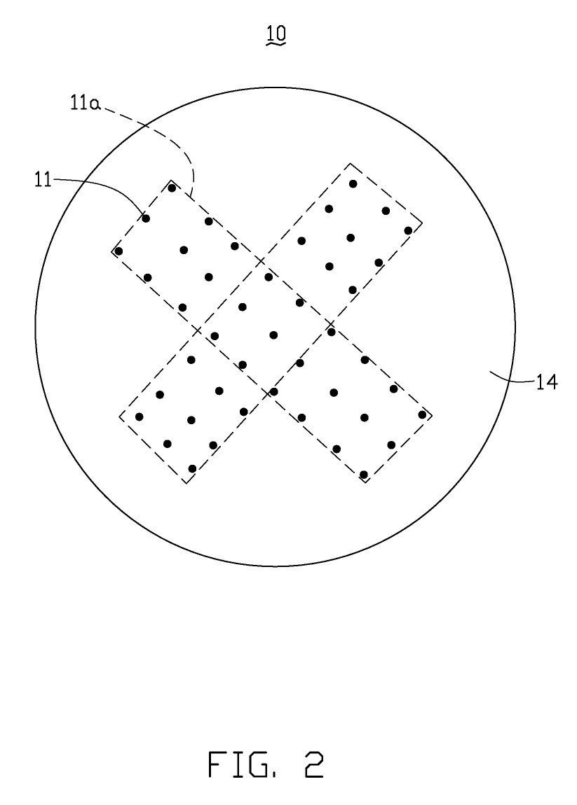

Referring to FIG. 2, the LEDs 11 are spread out on the third substrate 14 and arranged in an X shape to define a symbolic sign 11a, as indicated by an imaginary line in FIG. 2. The symbolic sign 11a is in the shape of a letter “X” and is illuminated by the red LEDs 11 to define a STOP sign. Alternatively, the red LEDs 11 may be made to blink or flash. The red LEDs 11 are spaced from each other at almost uniform intervals to disperse the heat spots on the substrate 14.

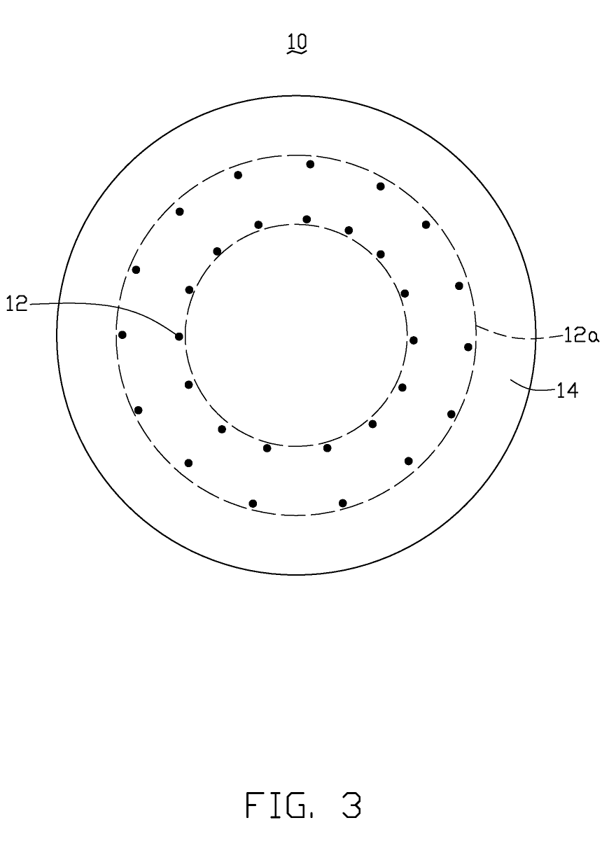

Referring to FIG. 3, the green LEDs 12 are spread out on the second substrate 15 and arranged in an annular shape to define a symbolic sign 12a in the shape of a letter “O”, as indicated by an imaginary line in FIG. 3. The green LEDs 12 of the symbolic sign 12a are illuminated to define a PASS sign. Alternatively, the green LEDs 12 may be made to blink or flash. The green LEDs 12 are spaced from each other at almost uniform intervals to disperse the heat spots on the substrate 15.

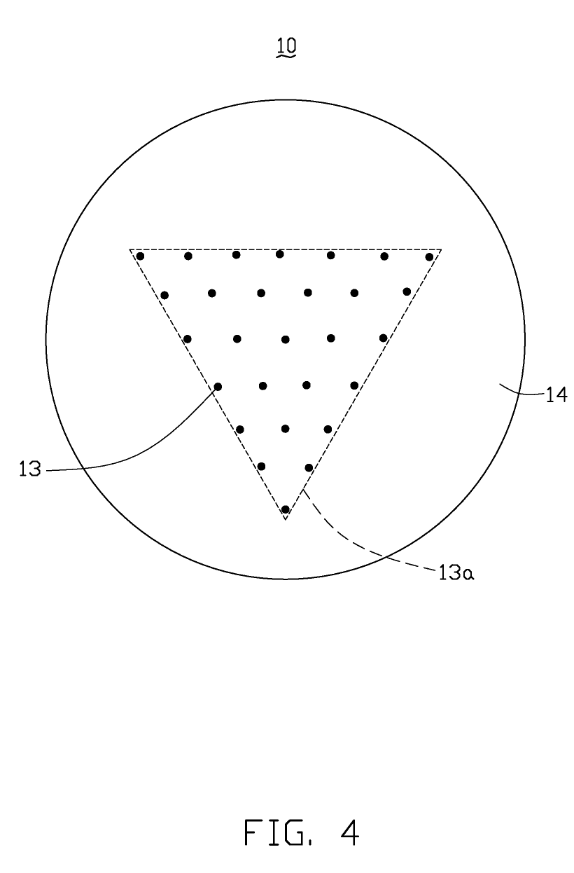

Referring to FIG. 4, the yellow LEDs 13 are spread out on the third substrate 16 and arranged in a triangular shape to define a symbolic sign 13a, as indicated by an imaginary line in FIG. 4. The yellow LEDs 13 of the symbolic sign 13a are illuminated to define a CAUTION sign. Alternatively, the yellow LEDs 13 may be made to blink or flash. The yellow LEDs 13 are spaced from each other at almost uniform intervals to disperse the heat spots on the substrate 16.

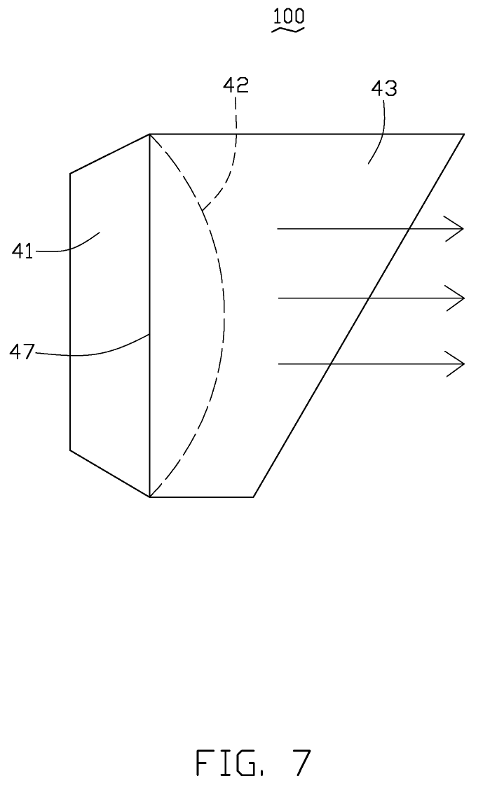

The supporting base 19 is made of a material having good heat conduction, such as copper. The first substrate 16 can be mounted on the supporting base 19 by soldering or fasteners. A layer of thermal grease can be spread between the first substrate 16 and the supporting base 19. The supporting base 19 is also used to connect the traffic light module 10 with a housing 41 (shown in FIG. 7) in which the traffic light module 10 is mounted.

In the traffic light module 10, the LEDs 11, 12, 13 are respectively mounted on the spaced substrates 14, 15, 16 so that heat generated by the LEDs 11, 12, 13 are dispersed to the different substrates 14, 15, 16 and can be more quickly dissipated than the conventional traffic light module in which all of the LEDs are mounted on a single substrate. Thus, the LEDs 11, 12, 13 can be maintained to work normally and have long service life.

In operation, the LEDs 11, 12, 13 are selectively controlled to illuminate, to thereby indicate the symbolic sign 11a, 12a, or 13a to the people in an alternate fashion. The colors of the LEDs 11, 12, 13 are not in any way limited to the color arrangements disclosed in this specification, but any suitable colors may be used. It is to be understood that a traffic light module can be formed only by two substrates and two groups of LEDs having two kinds different colors to display two symbolic signs in a similar manner to the traffic light module 10. In the traffic light module 10, the LEDs 11, 12, 13 of the symbolic signs 11a, 12a, 13a are arranged in different shapes to define symbolic signs having different meanings so that viewers, especially color-blind viewers, can be able to more noticeably distinguish the symbolic signs 11a, 12a, 13a. It is also to be understood that the symbolic signs 11a, 12a, 13a can have a same color as long as the LEDs 11, 12, 13 are arranged in different shapes from each other.

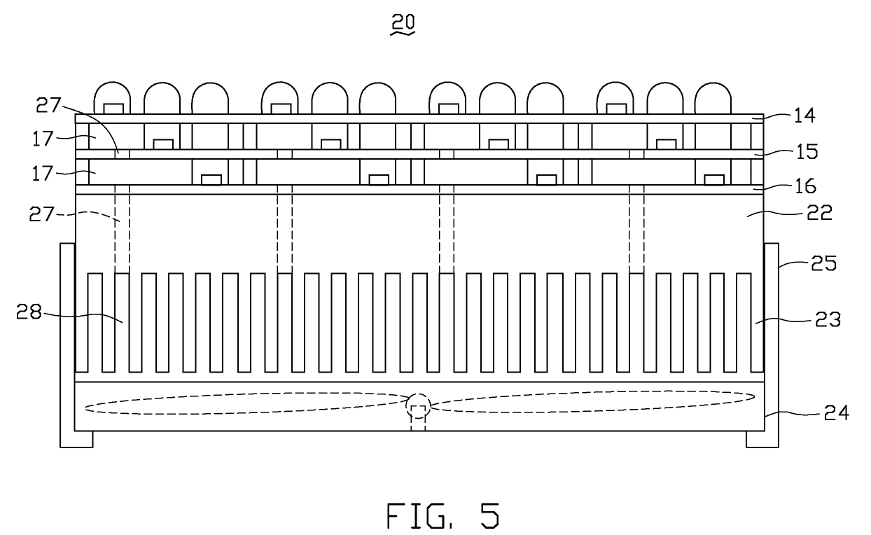

Referring to FIG. 5, a traffic light module 20 in accordance with a second embodiment is shown. The traffic light module 20 is similar to the traffic light module 10. The difference between the traffic light module 10 and the traffic light module 20 is that the traffic light module 20 has a supporting base 22 and a plurality of fins 23 extending from a bottom side of the supporting base 22, and a fan 24 is located below the fins 23 and connected to the supporting base 22 by a clip 25. Heat of the supporting base 22 can be transferred to the fins 23 and be quickly dissipated by forced airflow generated by the fan 24. A plurality of through holes 27 are defined to extend through the supporting base 22 and the substrates 15, 16 for communicating the gaps 17 with channels 28 defined between adjacent fins 23. Thus, the forced airflow can fully exchange heat with the fins 23, the supporting base 22 and the substrates 14, 15, 16 to enhance heat dissipation of the traffic light module 20.

It is to be understood that the substrates 14, 15, 16 can be made of transparent material, such as PMMA (polymethyl methacrylate), PC(polycarbonate), resin and so on. Thus, in a further alternative embodiment, it is not necessary to define the through holes 142, 143, 153 in the substrates 14, 15. Also the lenses 122, 132 are not necessarily to be elongated. The transparent material may also be flexible so that the substrates 14, 15, 16 are easy to form different, complicated shapes according to requirements.

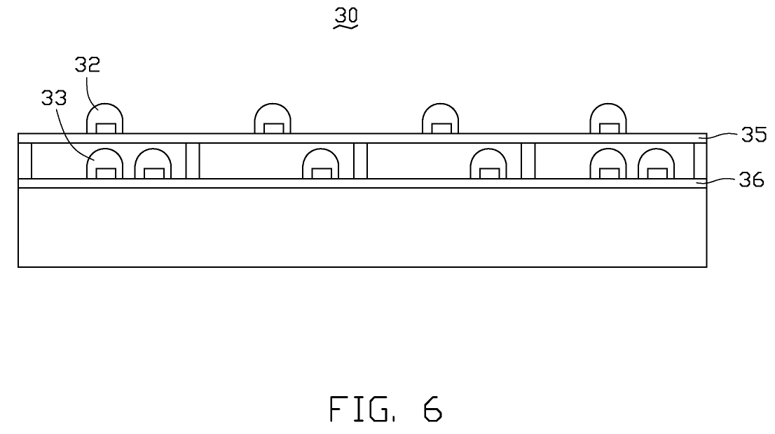

Referring to FIG. 6, a traffic light module 30 in accordance with a third embodiment is shown. The traffic light module 30 has two transparent substrates 35, 36 having two groups of LEDs 32, 33 respectively mounted thereon to define three kinds of symbolic signs. The LEDs 32 on the substrate 35 have blue LED chips and are arranged to define a blue symbolic sign. The LEDs 33 on the base 36 have yellow LED chips and are arranged to define a yellow symbolic sign. A portion of the blue LEDs 32 overlap a portion of the yellow LEDs 33 along a vertical direction of the substrates 35, 36, which is also light emitting direction of the LEDs 32, 33. When only the overlapped blue and yellow LEDs 32, 33 are illuminated, a green symbolic sign is defined by the traffic light module 30.

Referring to FIG. 7, a traffic light indictor 100 incorporating the traffic light module 10, 20 or 30 is shown. The traffic light indictor 100 includes a housing 41 with an opening 47 defined at a right lateral side thereof. The traffic light module 10, 20 or 30 is mounted in the housing 41 via the opening 47. Thereafter, the opening 47 is covered by a lens 42 indicated by an imaginary line. The lights of the traffic light module 10, 20 or 30 emit out through the lens 42. A high reflective material can be painted in an inside surface of the housing 41. Otherwise, the housing 41 can be made of steel or any other suitable material having a highly reflective inside surface. The housing 41 may be made to have a round, rectangular, square, or any other suitable shape.

The lens 42 is covered by a lens enclosure 43. The lens enclosure 43 is used to prevent sands, rains from entering the lens 42 and the housing 41 and keep the lens 42 and the housing 41 from being damaged.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A traffic light module comprising:
a first substrate having a first group of LEDs mounted thereon, the first group of LEDs being arranged in a first particular shape to define a first symbolic sign;
a second substrate having a second group of LEDs mounted thereon, the first and second substrate being spaced from each other and stacked with one above another with a gap defined between the first and second substrates, the second group of LEDs being arranged in a second particular shape to define a second symbolic sign.

2. The traffic light module as claimed in claim 1, wherein the first group of LEDs on the first substrate are arranged to have different shapes from the second group of LEDs on the second substrate.

3. The traffic light module as claimed in claim 1, wherein the first group of LEDs on the first substrate has a different color from the second group of LEDs on the second substrate.

4. The traffic light module as claimed in claim 1, wherein the first substrate defines a plurality of through holes corresponding to the LEDs on the second substrate, the LEDs on the second substrate extend out of the first substrate through the through holes.

5. The traffic light module as claimed in claim 1 further comprising a third substrate and a third group of LEDs mounted on the third substrate, wherein the first, second and third substrates are stacked with one above another, the second substrate is located between the first and third substrates, the first substrate defines a plurality of through holes corresponding to the LEDs of the second and third substrates, the second substrate defines a plurality of through holes corresponding to the LEDs of the third substrate, the LEDs on the second substrate extend out of the first substrate through the through holes of the first substrate, the LEDs on the third substrate extend out of the first substrate through the through holes of the first and second substrates.

6. The traffic light module as claimed in claim 5, wherein the LEDs on the first, second and third substrates are respectively arranged in an X shape, an annular shape, and a triangular shape.

7. The traffic light module as claimed in claim 6, wherein the LEDs of the X shape comprise red LED chips, the LEDs of the annular shape comprise green LED chips, and the LEDs of the triangular shape comprise yellow LED chips.

8. The traffic light module as claimed in claim 5, wherein the first, second, third substrates are planar and stacked along a vertical direction thereof.

9. The traffic light module as claimed in claim 1, wherein at least a heat pipe extends through the first and the second substrates in a thermal conductive manner.

10. The traffic light module as claimed in claim 1, wherein the first and the second substrates are mounted to a supporting base.

11. The traffic light module as claimed in claim 10, wherein a plurality of fins extend from a side of the supporting base.

12. The traffic light module as claimed in claim 11, wherein a fan is located facing the fins for blowing airflow towards the fins.

13. The traffic light module as claimed in claim 12, wherein a plurality of through holes are defined to extend through the supporting base and the substrates for driving the airflow from the fins into a gap between the substrates.

14. The traffic light module as claimed in claim 1, wherein the first and second substrates are made of transparent material.

15. The traffic light module as claimed in claim 14, wherein the first group of LEDs on the first substrate are arranged to have a different shape from the second group of LEDs on the second substrate.

16. The traffic light module as claimed in claim 15, wherein the first group of LEDs on the first substrate has a different color from the second group of LEDs on the second substrate.

17. The traffic light module as claimed in claim 16, wherein a portion of the first group of LEDs overlaps a portion of the second group of LEDs along light emitting direction of the LEDs.
